(19) United States
(12) Patent Application Publication
(10) Pub. No.: US 2003/0212663 A1
(43) Pub. Date: Nov. 13, 2003

(54) Neural network feedback for enhancing text search

(76) Inventors: Doug Leno, Meridian, ID (US); Sassan Sheedvash, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/141,298

(22) Filed: May 8, 2002

(51) Int. Cl. G06F 7/00

(52) U.S. Cl. 707/3

(57) ABSTRACT

An Artificial Neural Network (ANN) based search method and system for enhancing and assisting the task of specifying the required information in the query by combining the user's original query with additional information previously provided by the expert users. That is, the ANN based search system utilizes the expert community feedback in predicting the relevance of particular documents and dynamically builds statistical associations between the queries and known solutions, i.e., relevant documents, identified by the expert users.

### TECHNICAL FIELD

The present invention relates in general to a computer-based document search and retrieval, and in particular to ANN based document search and retrieval.

### BACKGROUND

The current approaches in knowledge management solutions can be categorized into one of two distinct strategies, the “knowledge-harvesting” approach and the “user-contribution/knowledge-sharing” approach.

In the knowledge-harvesting approach, the goal is to make explicit information available throughout an organization to be leveraged by the users, as needed, to complete their business tasks. Knowledge or information is typically indexed once, upon entry into the system, and used over and over by the various users in the organization. The presently available tools for implementing the knowledge-harvesting techniques include configurable, indexing and search engines capable of performing ad-hoc knowledge retrieval with minimal interaction with the users. The focus of such tools is to apply robust search, pattern matching and contextual analysis techniques to effectively and consistently process large amounts of information. The lack of user interaction, however, precludes the incorporation of the users' own expertise to influence the knowledge base or the suggested solutions proposed by the search engine. Also, these tools are typically incapable of handling uncertainties when presented with insufficient or imprecise information.

In the user-contribution/knowledge-sharing approach, the goal is to allow the users to add information and expertise to the system, and make it readily available throughout the organization. Although some of the knowledge-sharing related products or tools provide indexing and searching capabilities, generally they are not as robust or sophisticated as the knowledge-harvesting related products or tools. Additionally, in typical knowledge-sharing related products and tools, the process of incorporating the user's contribution is usually slow and the knowledge retrieval techniques are generally based on decision trees or ad-hoc and utilize brittle rule based system that are not scalable.

Accordingly, it is desirable to find a unified approach that utilizes the advantageous characteristics of these two distinct techniques. Therefore, the present invention utilizes a unified approach to dynamically improve the relevance of solutions suggested by the search engine by combining the efficiency and sophistication of the knowledge-harvesting approach with a more robust learning engine that incorporates the users' knowledge.

### SUMMARY OF THE INVENTION

The present invention is directed to a system and method which utilizes an Artificial Neural Network (ANN) to dynamically improve the relevance of solutions suggested by the search engine. The ANN based system modifies a user query with relevance feedback if the user query is related to expert queries and searches the knowledge store for documents or solutions related to the modified query.

In accordance with an embodiment of the present invention, the ANN based search method and system enhances and assists the task of specifying the required information in the query by combining the user's original query with additional information previously provided by expert users. That is, the ANN based search system utilizes domain-specific experts' feedback's in predicting the relevance of particular documents and dynamically builds statistical associations between the queries and known solutions, i.e., relevant documents, identified by the expert users.

In accordance with an aspect of the present invention, the ANN based search system is trained using expert queries from domain-specific experts. The system analyzes the text of documents determined to be relevant by the expert. The relevancy feedback from such analysis is then used to supplement or enhance the user query.

### BRIEF DESCRIPTION OF THE DRAWING

FIG. 1 is a block diagram of an ANN based search system in accordance with an embodiment of the present invention.

FIG. 2 is a flow chart describing the operation of the ANN based search system in accordance with an embodiment of the present invention.

### DETAILED DESCRIPTION

The present invention is readily implemented by presently available communication apparatus and electronic components. The invention finds ready application in virtually all commercial communications networks, including, but not limited to an intranet, world wide web, a Local Area Network (LAN), a Wide Area Network (WAN), a telephone network, a wireless network, and a wired cable transmission system.

Using a text retrieval system or a text searching tool, users can locate documents matching a specific topical query. A broadly framed query can result in identification of a large number of documents for the user to view. In an effort to reduce the number of documents, the user may modify the query to narrow its scope. In doing so, however, documents of interest may be eliminated because they do not exactly match the modified query, as intended by the user.

In an attempt to address this problem, some have proposed certain types of relevance predictors wherein the contents of a document are examined to determine if a user may find such document to be of interest, based on user-supplied information. While these approaches have some utility, they are limited because the prediction of relevance is made only on the basis of one attribute, e.g., word content.

The Artificial Neural Network (ANN) based search system of the present invention enhances or assists the task of specifying the required information in the query by combining the user's original query with additional information provided by the previous expert users. That is, the ANN based search system of the present invention utilizes domain-specific experts' feedback's in predicting the relevance of particular documents. For example, in the medical domain, expert queries are queries generated by physicians. In accordance with an embodiment of the present invention, the ANN based search system dynamically builds statistical associations between the queries and known solutions, i.e., relevant documents, previously identified by the experts. When a non-expert user presents a query that is similar to one of the expert queries, the ANN based search system enhances or supplements the user's original query with information from existing documents previously identified as being relevant by expert users.

An artificial neural network is a learning circuit that can be either software or hardware. In a software application, the ANN uses parallel connected cells or nodes that are essentially memory locations linked by various weights. The present invention can utilize any artificial neural network that learns what the output should be based on a given set of inputs with which it has been previously trained. After an ANN is trained, the ANN's node interconnect weights are saved in a file.

In accordance with an embodiment of the present invention, when a document is marked as relevant by the expert user, ANN based decision system 12 of the present invention analyzes the text of the relevant document, selecting additional terms or concepts that are statistically significant or relevant to the user's query (i.e., relevancy feedback), and modifies the original query with these additional terms or concepts. That is, the domain-specific experts review the solutions (i.e., relevant documents) provided by the untrained ANN based search system and marks relevant documents for textual analysis by the system, thereby training ANN based decision system 12. This training enables search engine 11 to refine the solutions based on inputs from the experts. It is appreciated that the knowledge store continuously increases over time as experts issues more queries and analyzes additional documents. This is a very efficient way of specifying the required information because it frees the user from having to think about all the possible relevant terms. Instead, the user deals with the ideas and concepts contained in the document. It also fits well with the known human preference of “I don't know what I want, but I'll know when I see it.”

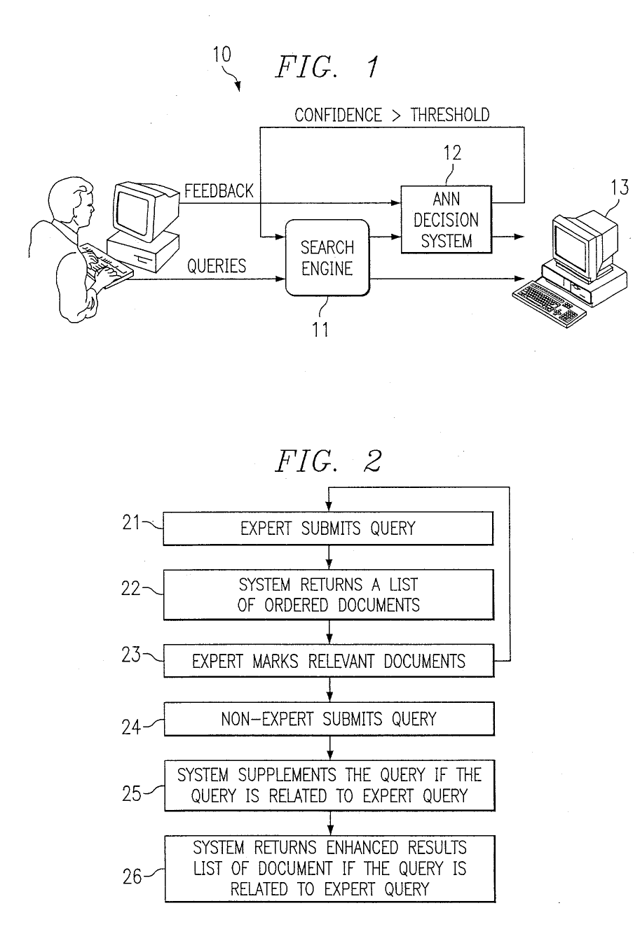

Turning now to FIG. 1, there is illustrated an embodiment of ANN based search or learning system 10 in accordance with the present invention. ANN based search system or overall system 10 comprises search engine 11 and ANN based decision system 12. ANN decision system 12 incorporates the relevance feedback of the expert users, e.g., physicians for medical domain, mechanics for automobile repair domain, pilots for airplane domain, etc., to dynamically influence and enhance the knowledge retrieval and delivery of solutions for a given knowledge harvesting system or search engine 11. The front-end subsystem or search engine 11 comprises configurable, indexing and search engines with advanced technologies, such as web crawlers, neural networks, summarization, concept analysis, and the like.

The second subsystem, or ANN based decision making system 12, correlates the user's queries to the relevancy of the solution documents. ANN decision system 12 determines the confidence of the relevance feedback with respect to the user query (i.e., the relatedness of the user query to expert's inputs and queries) and supplements the original query with known and controlled ranking inputs (i.e., relevance feedback) from the expert users. It is appreciated that any known technique, such as pattern matching, contextual analysis methods, etc., can be used to determine whether a user query is related to one or more expert queries. That is, ANN decision system 12 assigns a vote of confidence to the relevance feedback (provided by the expert user), and only when the confidence or relatedness measure exceeds a predetermined threshold, ANN decision system 12 incorporates the relevance feedback to dynamically influence and enhance the knowledge retrieval and delivery of solutions by search engine 11. This advantageously ensures the plasticity of ANN search system 10 without jeopardizing the performance of unassisted search engine 11 and stability of the previously established information. Therefore, the present invention enables the expert users to contribute to the decision-making capability of system 10 and enhance the relevancy of the suggested solutions by search engine 11 without the time consuming and expensive process of authoring or modifying the knowledge content directly. This advantageously allows the efficiency and usefulness of overall system 10 of the present invention to improve over time as expert users provide additional relevancy information in the context of their business needs and activities.

Turning now to flow chart of FIG. 2, in accordance with an embodiment of the present invention, an expert user submits a query in step 21 and system 10 returns a list of ordered documents selected by system 10 as relevant to the query in step 22. If the expert user determines that one or more of the selected documents are relevant to or answers (i.e., provides a solution) the query, such documents are marked as relevant to the query in step 23. When a similar or related query is initiated by a non-expert user in step 24, ANN based decision system 12 enhances or supplements the original query with previously identified terms and concepts and looks for statistical associations between the query and documents previously identified by the expert users as being solution or relevant to the original query (referred to herein as the (relevance feedback)) in step 25. System 10, enabled by the newly trained ANN based decision system 12, then presents the non-expert user with an enhanced results list of documents in step 26. The results are preferably ordered based on their relevancy according to the statistical associations or as previously determined by the expert users, such as by placing the most relevant document at the top of the list in step 26. That is, system 10 displays the enhanced results list of documents in display device 13, such as a computer. The ANN decision system 12 can use any known techniques to determine the relevancy of any document. For example, a combination of attribute-based and correlation-based prediction can be employed to rank the relevance of each document. Alternatively, multiple regression analysis can be utilized to combine the various factors.

In accordance with an aspect of the present invention, ANN based decision system 12 computes the confidence or relatedness of user query to one or more of expert queries and utilizes the relevance feedback only when the confidence or relatedness exceeds certain threshold, thereby advantageously harnessing the power of ANN decision system 12 without perturbing the desired performance of unassisted search engine 11. For example, the ANN based system utilizes an expert query if it is related to the user query by more than 80%, as determined by any known knowledge-harvesting techniques.

In accordance with an embodiment of the present invention, system 10 can utilize the learned associations of queries and relevant knowledge or feedback (i.e., terms and concepts) to categorize the relevant knowledge itself into specific clusters of hidden knowledge within the corpus of the knowledge store or data set, e.g., database. It is appreciated that the boundaries of these domain-specific clusters will sharpen over time as system 10 collects and processes additional inputs from the expert users. Currently, such clustering efforts are very expensive, labor-intensive, and require a high degree of human expertise and interaction, especially to large knowledge store or data set. The ANN based decision system 12 of the present invention, however, captures the experience and knowledge of the expert and non-expert users as they use system 10 (i.e., knowledge tool) and scales easily as the knowledge store and user population grows. Additionally, the organization of the clusters into a meaningful taxonomy wherein the users can navigate explicitly through the clusters will only enhance the clustering effect, thereby eliminating the necessity of formulating a query that fully and accurately expresses the user's knowledge requirement. In other words, instead of the user refining and narrowing his/her search, the system divides the knowledge store into domain-specific clusters so that user searches only the relevant portion of the knowledge store. Accordingly, the user can formulate a broad query and rely on system 10 of the present invention to nevertheless provide relevant and meaningful answers (i.e., documents) by searching only the relevant domain-specific clusters instead of searching the entire knowledge store. For example, when system 10 is presented with a query relating to car, the system does not search the entire knowledge store, but only those clusters related to car.

What is claimed is:

1. An Artificial Neural Network (ANN) based method for searching documents in a knowledge store, comprising the steps of:
searching the knowledge store for documents relevant to a user query;
determining whether said user query relates to one or more previously processed expert query;
modifying said user query with relevance feedback to provide a modified query if it is determined that said user query relates to one of said expert queries; and
searching the knowledge store for documents relevant to said modified query to provide relevant documents.

2. The method of claim 1 wherein the step of determining determines said user query is related to one of said expert queries if a relatedness measure exceeds a predetermined threshold.

3. The method of claim 1 further comprising:
step of determining statistical associations between said user query and said relevant documents.

4. The method of claim 3 further comprising:
step of displaying said relevant documents in order of its relevancy based on at least one of the following: said statistical associations and said relevance feedback.

5. The method of claim 3 further comprising:
step of clustering said knowledge store based on at least one of the following: said statistical associations and said relevancy feedback.

6. A method for searching documents in a knowledge store, comprising the steps of:
providing an Artificial Neural Network (ANN) system for enhancing user's search for documents in the knowledge store;
training the ANN system using expert queries to supplement user queries;
determining whether a user query relates to one or more previously processed expert query;
modifying said user query with relevance feedback to provide a modified query if it is determined that said user query relates to one said expert queries; and
searching the knowledge store for documents relevant to said modified query to provide relevant documents.

7. The method of claim 6 wherein the step of training comprises:
searching the knowledge store for documents relevant to an expert query from a domain-specific expert;
marking one or more of said relevant documents as being relevant if it is determined that a document is relevant to said expert query by said expert; and
analyzing text of said marked document to determine relevance feedback.

8. The method of claim 7 wherein said relevance feedback represents terms and concepts that are statistically relevant to said expert query.

9. An artificial neural network (ANN) system for searching documents in a knowledge store, comprising:
a search engine for searching the knowledge store for documents relevant to a user query; and
an ANN decision system for determining whether said user query relates to one or more previously processed expert query, and modifying said user query with relevance feedback to provide a modified query if it is determined that said user query relates to one of said expert queries; and
wherein said search engine is operable to search the knowledge store for documents relevant to said modified query to provide relevant documents.

10. The ANN system of claim 9 wherein said ANN decision system is operable to determine said user query is related to one of said expert queries if the relatedness measure exceeds a predetermined threshold.

11. The ANN system of claim 9 wherein said ANN decision system is operable determine statistical associations between said user query and said relevant documents.

12. The ANN system of claim 11 further comprising:
a display device for displaying said relevant documents in order of its relevancy based on at least one of the following: said statistical associations and said relevance feedback.

13. The ANN system of claim 11 wherein said ANN decision system is operable to cluster said knowledge store based on at least one of the following: said statistical associations and said relevancy feedback.
